(19) United States
(12) Patent Application Publication
(10) Pub. No.: US 2023/0177557 A1
(43) Pub. Date: Jun. 8, 2023

(54) APPARATUS, SYSTEMS, AND METHODS TO IDENTIFY CONSUMER CONTENT EXPOSURE

(71) Applicant: NC Ventures, LLC d/b/a NCSolutions, New York, NY (US)

(72) Inventors: Leslie A. Wood, Copake, NY (US); Amy Crooks, Jersey City, NJ (US); Riley Jessen, Chicago, IL (US); Andrew Bernier, La Grange, IL (US)

(21) Appl. No.: 17/900,448

(22) Filed: Aug. 31, 2022

Related U.S. Application Data
(60) Provisional application No. 63/323,872, filed on Mar. 25, 2022.
(60) Provisional application No. 63/287,423, filed on Dec. 8, 2021.

(51) Int. Cl. G06Q 30/02

(52) U.S. Cl. CPC G06Q 30/0242; G06Q 30/0201

(57) ABSTRACT

Apparatus, systems, and methods to identify consumer content exposure are disclosed. An example apparatus includes at least one memory; machine readable instructions; and processor circuitry to at least one of instantiate or execute the machine readable instructions to detect a first exposure of a first consumer to a marketing campaign during a first time period; identify the first exposure as a first recency exposure; detect a second exposure of the first consumer to the marketing campaign during one of the first time period or a second time period; when the second exposure is detected during the first time period, identify the first time period as an iterative frequency exposure; and when the second exposure is detected during the second time period, identify the second exposure as a second recency exposure.

### RELATED APPLICATIONS

This patent claims the benefit of U.S. Provisional Patent Application No. 63/287,423, which was filed on Dec. 8, 2021, and U.S. Provisional Patent Application No. 63/323,872, which was filed on Mar. 25, 2022. U.S. Provisional Patent Application No. 63/287,423 and U.S. Provisional Patent Application No. 63/323,872 are hereby incorporated herein by reference in their entireties. Priority to U.S. Provisional Patent Application No. 63/287,423 and U.S. Provisional Patent Application No. 63/323,872 is hereby claimed.

### FIELD OF THE DISCLOSURE

This disclosure relates generally to market research analysis and, more particularly, to apparatus, systems, and methods to identify consumer content exposure.

### BACKGROUND

During a marketing campaign, delivery of content such as advertisements can be measured based on exposure of consumers to the advertisements. Consumers may be exposed to the advertisements more than once during the advertising campaign.

### BRIEF DESCRIPTION OF THE DRAWINGS

FIG. 1 illustrates an example market analysis system constructed in accordance with teachings of this disclosure and including exposure analyzing circuitry for analyzing consumer exposures to content associated with a marketing campaign.

FIG. 2 is a block diagram of the example exposure analyzing circuitry of FIG. 1.

FIG. 3 is a diagram illustrating a first process for identifying consumer exposure to content associated with a marketing campaign that may be implemented by the example exposure analyzing circuitry of FIGS. 1 and/or 2.

FIG. 4 is a diagram illustrating a second process for identifying consumer exposure to the content associated with the marketing campaign that may be implemented by the example exposure analyzing circuitry of FIGS. 1 and/or 2

FIG. 5A is a table including sample data for analysis by the example exposure analyzing circuitry of FIGS. 1 and/or 2 and resulting consumer exposures determined by the exposure analyzing circuitry using a first method of analysis.

FIG. 5B is a table including sample data for analysis by the example exposure analyzing circuitry of FIGS. 1 and/or 2 and resulting consumer exposures determined by the exposure analyzing circuitry using a second method of analysis.

FIG. 6 is a flowchart representative of example machine readable instructions and/or example operations that may be executed by example processor circuitry to implement the exposure analyzing circuitry of FIG. 2.

FIG. 7 is a flowchart representative of example machine readable instructions and/or example operations that may be executed by example processor circuitry to implement block 612 of FIG. 6.

FIG. 8 is another flowchart representative of example machine readable instructions and/or example operations that may be executed by example processor circuitry to implement block 612 of FIG. 6.

FIG. 9 is a block diagram of an example processing platform including processor circuitry structured to execute the example machine readable instructions and/or the example operations of FIG. 6-8 to implement the exposure analyzing circuitry of FIGS. 1 and/or 2.

FIG. 10 is a block diagram of an example implementation of the processor circuitry of FIG. 9.

FIG. 11 is a block diagram of another example implementation of the processor circuitry of FIG. 9.

In general, the same reference numbers will be used throughout the drawing(s) and accompanying written description to refer to the same or like parts. The figures are not to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Delivery of content such as advertisements for a marketing campaign can be measured based on metrics indicative of exposure of consumers to the advertisements. For instance, reach is a metric indicative of a unique audience exposed to the marketing campaign, such as a number of unique consumers exposed to advertisements of the campaign. A marketing campaign may span a duration of time such as weeks or months. An owner of the marketing campaign may repeatedly deliver the advertisements so that a message associated with the campaign is remembered by consumers. Thus, during the marketing campaign, consumers may be exposed to the advertisements multiple times.

Frequency is a metric indicative of repeated exposure of the consumers to the marketing campaign. Thus, if a consumer is exposed to the same marketing campaign multiple times, that consumer is counted as a single consumer for purposes of determining reach. However, the repeated exposures are considered for purposes of measuring frequency.

Although a consumer may be exposed to the marketing campaign multiple times, the timing of the repeated exposures can vary. For instance, for a campaign having a duration of four weeks, a consumer may be exposed to an advertisement associated with the campaign three times in the first week, zero times in the second week, and once in the third week. The initial exposure to the marketing campaign is measured as reach. The repeated exposures to the marketing campaign in the first week and the third week after the initial exposure of the consumer to the advertisement in the first week are measured as frequency. However, such a frequency measurement does not distinguish between the repeated exposures that occurred in the first week relative to the exposure that did not occur again until the third week (i.e., the exposure did not occur again until after a period of time elapsed between the first week and the third week).

The exposure of the consumer to the advertisement in the third week can be indicative of recency delivery of the message because a period of time has lapsed from the initial exposure in the first week. Put another way, the exposure in the third week could be considered to be an instance of repeat reach associated with the marketing campaign over the duration of the campaign. Such recency delivery of the message can be distinguished from iterative frequency of the delivery, or pure repeated exposure to the campaign, where the repeated exposures could occur all in one day, all in one week, etc. of the campaign and, thus, may or may not occur throughout the duration of the campaign (e.g., the repeated frequency exposures may or may not occur across weeks or months of the campaign and instead, may occur in the same week of the campaign). However, because reach as representative of an initial exposure is typically applied to campaigns of all durations, the value of reach as indicative of delivering a message regularly to a consumer and the value of frequency as repeating the message to the consumer so the message is remembered by the consumer has been affected. Instead, frequency exposures often include exposures that could be considered to be reach based on the duration of time between exposures during the duration of the campaign.

Disclosed herein are example apparatus, systems, and methods to identify instances of exposure of consumers to content such as advertisements associated with a marketing campaign and to classify the exposures as associated with (a) iterative frequency indicative of repetition in delivery of the content, or (b) recency exposure, which can indicate delivery of content over a duration the campaign (i.e., repeat reach). Examples disclosed herein separate or differentiate the frequency metric associated with delivery of impressions of a campaign (e.g., delivery of an advertisement providing a consumer an opportunity to view the advertisement) into recency exposures and iterative frequency exposures. As a result, examples disclosed herein provide for more accurate identification of multiple exposures to a campaign and insights with respect to incidence(s) of exposure of the delivered impressions over the duration of the marketing campaign. For example, the recency exposures can be used to track regular (e.g., periodic) exposure to the campaign over the duration of the campaign as compared to repeated exposure to the campaign within a condensed time frame (e.g., exposure within the same week or the same day).

Some examples disclosed herein identify the recency exposure by detecting a first exposure to the campaign that occurs within a respective time period of the campaign. In such examples, the campaign can be divided into measurement time periods of, for instance, n number of days. Examples disclosed herein identify the first exposure to the campaign in each time period—or, put another way, the reach of each time period. Examples disclosed herein use the reach in each time period to identify recency exposures (i.e., repeat reach events). Thus, examples disclosed herein efficiently use the reach metric to output a new metric that represents recency exposure. As a result, examples disclosed herein prevent inefficient use computing resources by reducing an amount of resources consumed to determine recency exposures in view of the determination of reach for the campaign.

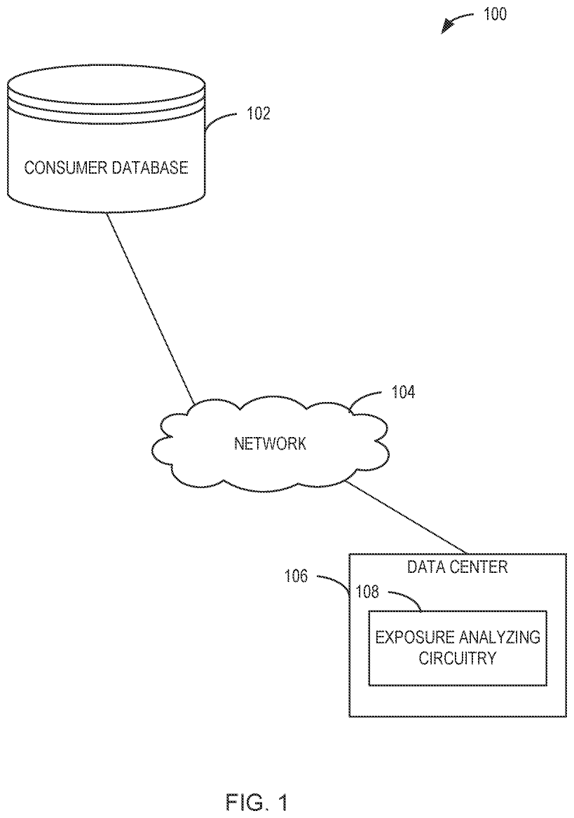

FIG. 1 illustrates an example system 100 including a consumer database 102, a network 104, a data center 106, and exposure analyzing circuitry 108.

The example consumer database 102 of FIG. 1 includes consumer level data, where consumers can include households, individuals, electronic devices that can display content such as advertising (e.g., a smartphone). Thus, as used herein, the term “consumer” refers to a unit of reach or impressions that is being measured (e.g., persons, devices, households). The example consumer database 102 stores data indicative of delivered impressions associated with a marketing campaign (e.g., advertisements, promotions), a duration of the marketing campaign, and a consumer population size. The consumer database 102 includes an indication of whether a consumer is a reached consumer. For instance, the consumer data can include a flag to indicate exposure of a consumer to an advertisement and data as to when the exposure occurred.

In the example of FIG. 1, the network 104 facilitates communication between the consumer database 102 and/or the data center 106. In some examples, any number of consumer databases 102 can be communicatively coupled to the data center 106 via the network 104. The communication provided by the network 104 can be via, for example, the Internet, an Ethernet connection, a USB cable, etc.

In the example of FIG. 1, the data center 106 is an execution environment used to implement the exposure analyzing circuitry 108. In some examples, the data center 106 is associated with a media monitoring entity. In some examples, the data center 106 can be a physical processing center (e.g., a central facility of the media monitoring entity, etc.). Additionally or alternatively, the data center 106 can be implemented via a cloud service (e.g., AWS®, etc.).

The exposure analyzing circuitry 108 of FIG. 1 accesses and analyzes the data stored in the consumer database 102 to classify instances of exposure of consumers to the marketing campaign. In particular, the exposure analyzing circuitry 108 differentiates repeat consumer exposures, or frequency of the campaign, to identify (a) exposures that are repeat exposures within a particular time period or window of the marketing campaign (e.g., repeat exposures in a first week of the marketing campaign) and (b) exposures that occur across time periods or windows of the campaign (e.g., an exposure occurring in a second week and a fourth week of the marketing campaign). The example exposure analyzing circuitry 108 of FIG. 1 classifies the repeat exposures as iterative frequency exposures. The exposure analyzing circuitry 108 classifies the exposures occurring across time periods or windows as recency exposures. As disclosed herein, in some examples, the exposure analyzing circuitry 108 identifies instances of reach in each time period of the marketing campaign, or a first exposure to the campaign within each time period, to determine the recency exposures.

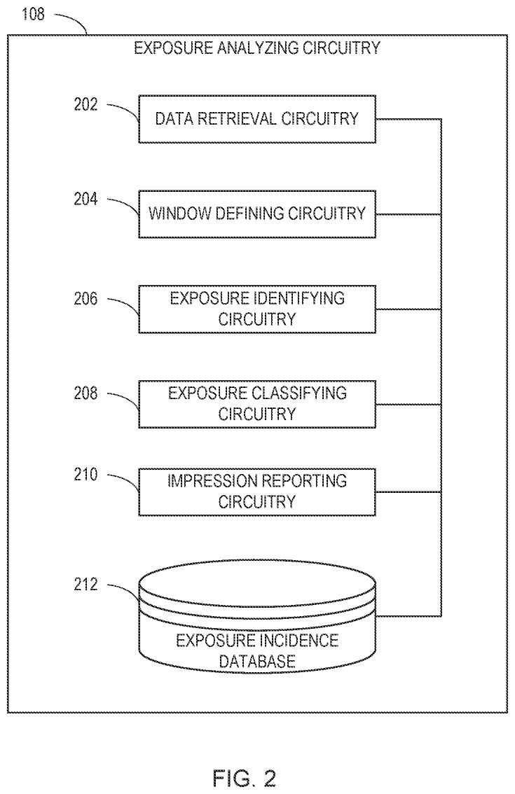

FIG. 2 is a block diagram of the exposure analyzing circuitry 108 to identify exposures to a marketing campaign. The exposure analyzing circuitry 108 of FIG. 2 may be instantiated (e.g., creating an instance of, bring into being for any length of time, materialize, implement, etc.) by processor circuitry such as a central processing unit executing instructions. Additionally or alternatively, the exposure analyzing circuitry 108 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers executing on the microprocessor.

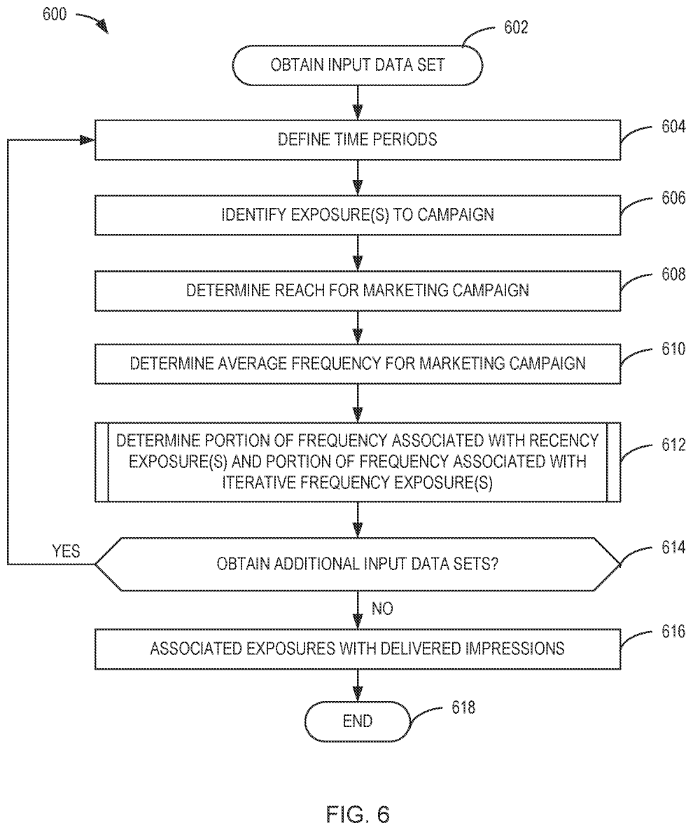

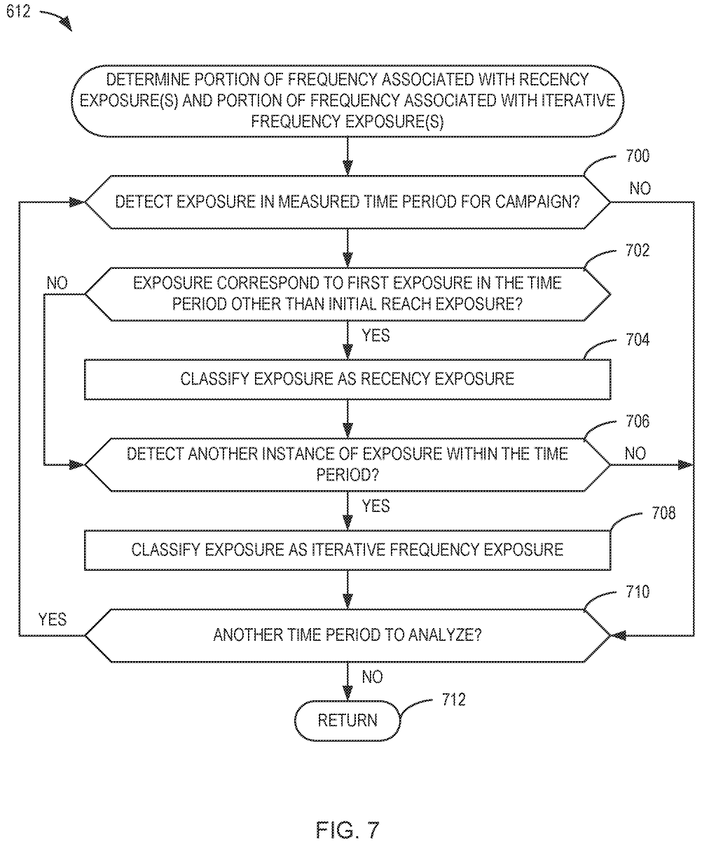

The example exposure analyzing circuitry 108 of FIG. 2 includes data retrieval circuitry 202, window defining circuitry 204, exposure identifying circuitry 206, exposure classifying circuitry 208, impression reporting circuitry 210, and an example exposure incidence database 212. In some examples, the data retrieval circuitry 202 is instantiated by processor circuitry executing data retrieval instructions and/or configured to perform operations such as those represented by the flowchart of FIG. 6. In some examples, the window defining circuitry 204 is instantiated by processor circuitry executing window defining instructions and/or configured to perform operations such as those represented by the flowchart of FIG. 6. In some examples, the exposure identifying circuitry 206 is instantiated by processor circuitry executing exposure identifying instructions and/or configured to perform operations such as those represented by the flowchart of FIG. 6. In some examples, the exposure classifying circuitry 208 is instantiated by processor circuitry executing exposure classifying instructions and/or configured to perform operations such as those represented by the flowcharts of FIGS. 6, 7, and/or 8. In some examples, the impression reporting circuitry 210 is instantiated by processor circuitry executing impression reporting instructions and/or configured to perform operations such as those represented by the flowchart of FIG. 6

The example data retrieval circuitry 202 accesses consumer exposure data stored in the consumer database 102. In some examples, the data retrieval circuitry 202 accesses content in the consumer database 102 in response to a query, on a manual basis, on a periodic basis, or on a scheduled basis. For example, the data retrieval circuitry 202 may access the consumer database 102 once a week, once a month, once a quarter, etc. to analyze consumer exposure to the marketing campaign. In some examples, the data retrieval circuitry 202 harmonizes, normalizes, and/or otherwise formats the data accessed from the consumer database 102.

The example window defining circuitry 204 receives user inputs with respect to time periods for measuring exposures of the consumers to the marking campaign. The user inputs can define n number of days that are used by the window defining circuitry 204 to divide the marketing campaign into time periods or windows during which the exposures are to be measured (e.g., one week time periods). For instance, if the user input specifies that n=6 days, then the window defining circuitry 204 defines measurement time periods for the duration of the marketing campaign as a first measurement time period including days 1-6 of the marketing campaign, a second measurement time period as days 7-12 of the marking campaign, etc.

The user input(s) received by the window defining circuitry 204 define frequency windows for detecting repeat exposures to the campaign. The user inputs can define whether the frequency window should be (a) a set window corresponding to the measurement time periods for the campaign or (b) a rolling window based on the occurrence of recency exposures. Based on the user inputs, the window defining circuitry 204 defines frequency windows for detecting repeat exposures to the campaign. In some examples, the frequency windows are the same as the measurement time periods. In other examples, the frequency windows are defined based on the detection of recency exposures (e.g., a window occurring within 6 days of a recency exposure).

The example exposure identifying circuitry 206 of FIG. 2 identifies exposures to the marketing campaign based on the delivered impressions as set forth in the consumer exposure data from the consumer database 102. In some examples, the exposure identifying circuitry 206 determines exposures based on the consumer data indicating which consumers were exposed and the respective date(s) of the exposure(s).

The example exposure classifying circuitry 208 analyzes the respective exposures occurring in each measurement time period or window to determine whether the exposure is indicative of (a) reach (i.e., a first exposure to the marketing campaign); (b) a recency exposure (i.e., a first exposure occurring in a time period of the campaign, other than the exposure used to determine reach); (c) an iterative frequency exposure (i.e., a repeat exposure occurring within a time period, such as an exposure occurring in the same time period as a recency exposure).

In the example of FIG. 2, the exposure classifying circuitry 208 calculates reach as unique consumers exposed to the marketing campaign. For example, if the measurement time periods are defined by n=6 days, the exposure classifying circuitry 208 identifies a first exposure for each consumer in each of the time periods (i.e., the first instance of exposure in days n1-n6 for each time period). The exposure classifying circuitry 208 flags the first exposure in the respective measurement times periods.

The exposure classifying circuitry 208 uses the first exposure (i.e., an initial exposure) to the campaign for respective ones of the consumers across all of the time periods to determine reach. The exposure classifying circuitry 208 can calculate an average frequency of the campaign based on the reach for the campaign and the delivered impressions.

In some examples, the exposure classifying circuitry 208 classifies each instance of reach in a measurement time period, other than the initial reach exposure, as a recency exposure or an instance of repeat reach. For instance, if the exposure classifying circuitry 208 identifies a first exposure occurring in the first time period as the reach exposure, the exposure classifying circuitry 208 classifies a first exposure occurring in the second time period as a recency exposure. Put another way, the exposure classifying circuitry 208 classifies the first detection of reach in the second time period as a recency exposure. In some examples, the exposure classifying circuitry 208 treats the initial reach as a recency exposure.

In the example of FIG. 2, the exposure classifying circuitry 208 classifies repeat exposure(s) that occur within the same time period or window as the reach exposure or as the recency exposure(s) as iterative frequency exposure(s). For example, if the exposure classifying circuitry 208 identifies a first exposure of a consumer in a second time period of the campaign as a recency exposure and the exposure identifying circuitry 206 identifies another exposure of the consumer in the second time period, then the exposure classifying circuitry 208 identifies the second exposure as an iterative frequency exposure, or a repeat exposure within the second time period. As disclosed herein, in some examples, the frequency window for detecting iterative disclosures is based on the measurement time periods for the marketing campaign (e.g., one week time periods). In other examples, the frequency windows are defined based on the occurrence of recency exposures. In such examples, whenever a recency exposure is detected, the frequency window is defined as including n number of days following the recency exposure, such that any exposure occurring within the n number of days of the recency exposure is identified as an iterative frequency exposure. In some examples, the exposure classifying circuitry 208 stores the values associated with reach, frequency, recency exposure(s), and iterative frequency exposure(s) in the exposure incidence database 212.

The impression reporting circuitry 210 analyzes the exposure classifications to output reports associating the delivered impressions with reach and the differentiated metrics for frequency, iterative frequency exposure, and recency exposure.

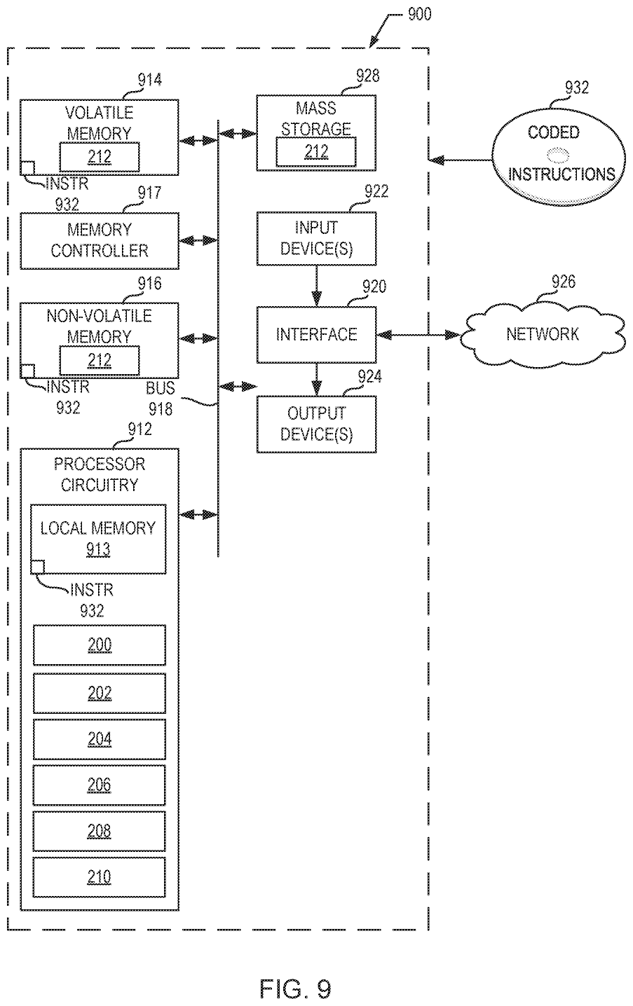

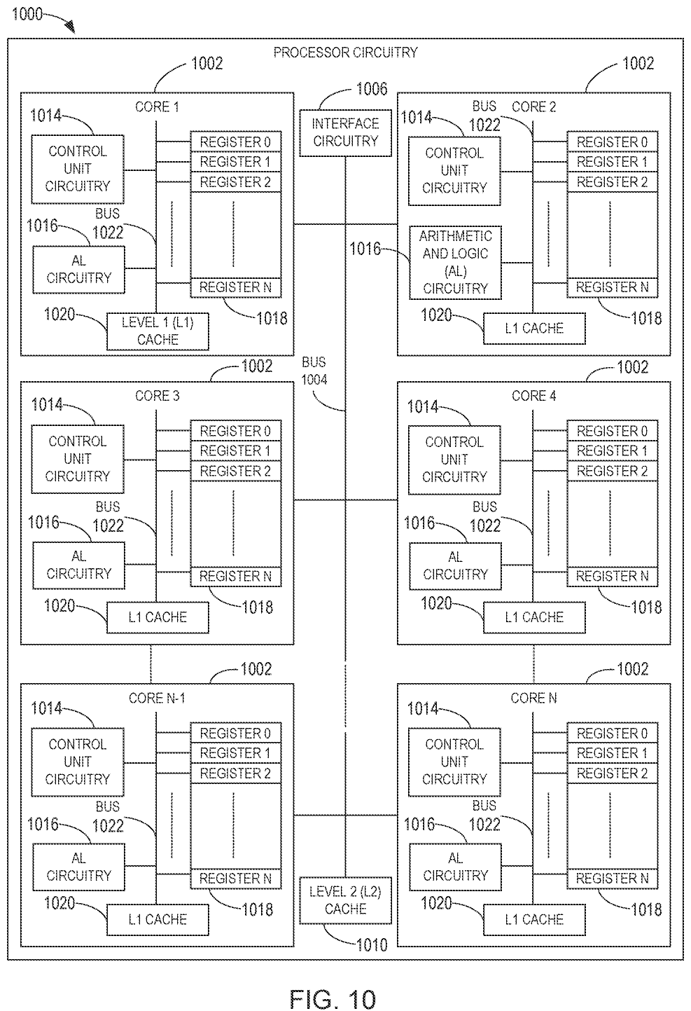

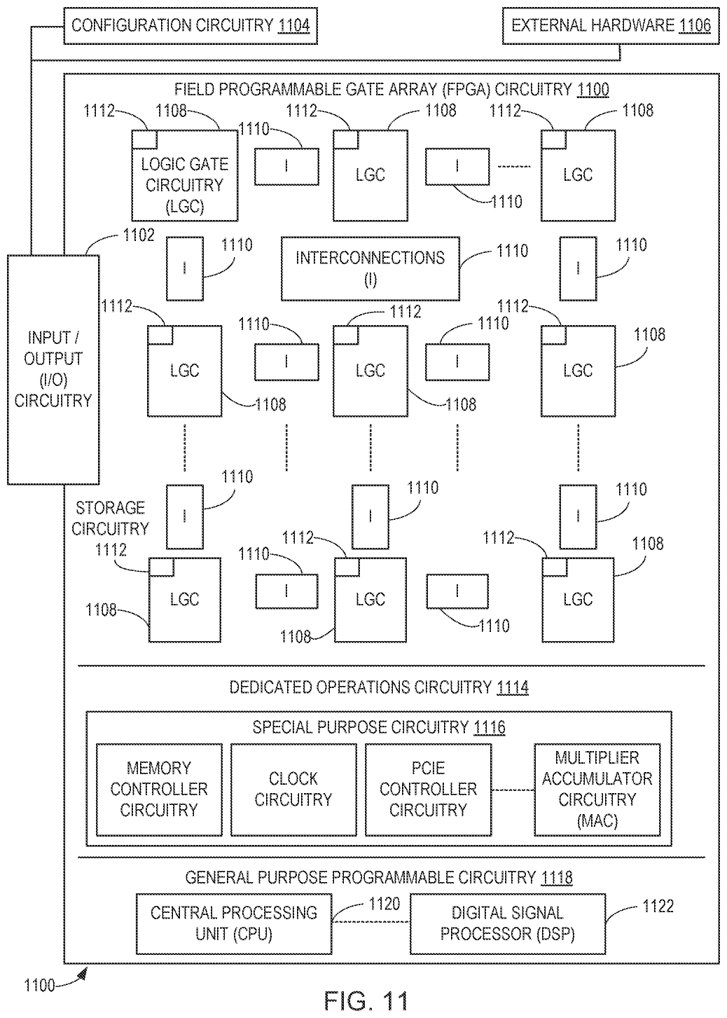

In some examples, the exposure analyzing circuitry includes means for retrieving data. For example, the means for retrieving may be implemented by the data retrieval circuitry 202. In some examples, the data retrieval circuitry 202 may be instantiated by processor circuitry such as the example processor circuitry 912 of FIG. 9. For instance, the data retrieval circuitry 202 may be instantiated by the example microprocessor 1000 of FIG. 10 executing machine executable instructions such as those implemented by at least blocks 602, 614 of FIG. 6. In some examples, the data retrieval circuitry 202 may be instantiated by hardware logic circuitry, which may be implemented by an ASIC or the FPGA circuitry 1100 of FIG. 11 structured to perform operations corresponding to the machine readable instructions. Additionally or alternatively, the data retrieval circuitry 202 may be instantiated by any other combination of hardware, software, and/or firmware. For example, the data retrieval circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the exposure analyzing circuitry includes means for defining window. For example, the means for window defining may be implemented by the window defining circuitry 204. In some examples, the window defining circuitry 204 may be instantiated by processor circuitry such as the example processor circuitry 912 of FIG. 9. For instance, the window defining circuitry 204 may be instantiated by the example microprocessor 1000 of FIG. 10 executing machine executable instructions such as those implemented by at least block 604 of FIG. 6. In some examples, the window defining circuitry 204 may be instantiated by hardware logic circuitry, which may be implemented by an ASIC or the FPGA circuitry 1100 of FIG. 11 structured to perform operations corresponding to the machine readable instructions. Additionally or alternatively, the window defining circuitry 204 may be instantiated by any other combination of hardware, software, and/or firmware. For example, the window defining circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the exposure analyzing circuitry includes means for identifying exposures. For example, the means for identifying may be implemented by the exposure identifying circuitry 206. In some examples, the exposure identifying circuitry 206 may be instantiated by processor circuitry such as the example processor circuitry 912 of FIG. 9. For instance, the exposure identifying circuitry 206 may be instantiated by the example microprocessor 1000 of FIG. 10 executing machine executable instructions such as those implemented by at least block 606 of FIG. 6. In some examples, the exposure identifying circuitry 206 may be instantiated by hardware logic circuitry, which may be implemented by an ASIC or the FPGA circuitry 1100 of FIG. 11 structured to perform operations corresponding to the machine readable instructions. Additionally or alternatively, the exposure identifying circuitry 206 may be instantiated by any other combination of hardware, software, and/or firmware. For example, the exposure identifying circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

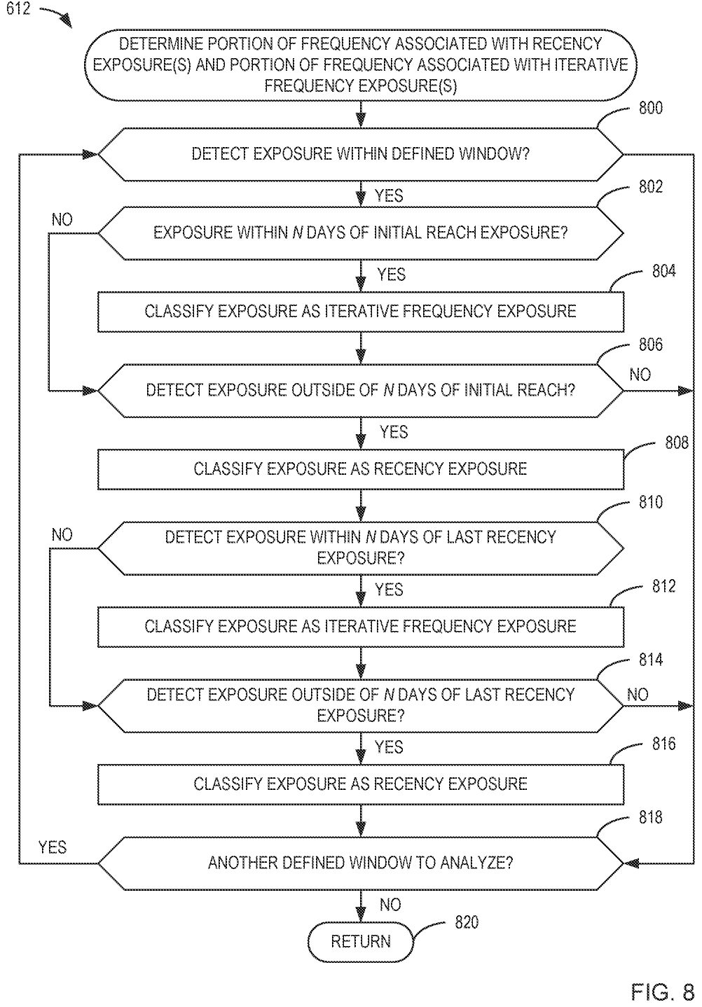

In some examples, the exposure analyzing circuitry includes means for classifying exposures. For example, the means for classifying may be implemented by the exposure classifying circuitry 208. In some examples, the exposure classifying circuitry 208 may be instantiated by processor circuitry such as the example processor circuitry 912 of FIG. 9. For instance, the exposure classifying circuitry 208 may be instantiated by the example microprocessor 1000 of FIG. 10 executing machine executable instructions such as those implemented by at least blocks 608-612 of FIG. 6, blocks 700-712 of FIG. 7, and/or blocks 800-820 of FIG. 8. In some examples, the exposure classifying circuitry 208 may be instantiated by hardware logic circuitry, which may be implemented by an ASIC or the FPGA circuitry 1100 of FIG. 11 structured to perform operations corresponding to the machine readable instructions. Additionally or alternatively, the exposure classifying circuitry 208 may be instantiated by any other combination of hardware, software, and/or firmware. For example, the exposure classifying circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the exposure analyzing circuitry includes means for reporting. For example, the means for reporting may be implemented by the impression reporting circuitry 210. In some examples, the impression reporting circuitry 210 may be instantiated by processor circuitry such as the example processor circuitry 912 of FIG. 9. For instance, the impression reporting circuitry 210 may be instantiated by the example microprocessor 1000 of FIG. 10 executing machine executable instructions such as those implemented by at least block 616 of FIG. 6. In some examples, the impression reporting circuitry 210 may be instantiated by hardware logic circuitry, which may be implemented by an ASIC or the FPGA circuitry 1100 of FIG. 11 structured to perform operations corresponding to the machine readable instructions. Additionally or alternatively, the impression reporting circuitry 210 may be instantiated by any other combination of hardware, software, and/or firmware. For example, the impression reporting circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the exposure analyzing circuitry 108 of FIG. 1 is illustrated in FIG. 2, one or more of the elements, processes, and/or devices illustrated in FIG. 2 may be combined, divided, re-arranged, omitted, eliminated, and/or implemented in any other way. Further, the example data retrieval circuitry 202, the example window defining circuitry 204, the example exposure identifying circuitry 206, the example exposure classifying circuitry 208, the example impression reporting circuitry 210, the example exposure incidence database 212 and/or, more generally, the example exposure analyzing circuitry 108 of FIG. 1, may be implemented by hardware alone or by hardware in combination with software and/or firmware. Thus, for example, any of the example data retrieval circuitry 202, the example window defining circuitry 204, the example exposure identifying circuitry 206, the example exposure classifying circuitry 208, the example impression reporting circuitry 210, the example exposure incidence database 212 and/or, more generally, the example exposure analyzing circuitry 108, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example exposure analyzing circuitry 108 of FIG. 1 may include one or more elements, processes, and/or devices in addition to, or instead of, those illustrated in FIG. 2, and/or may include more than one of any or all of the illustrated elements, processes, and devices.

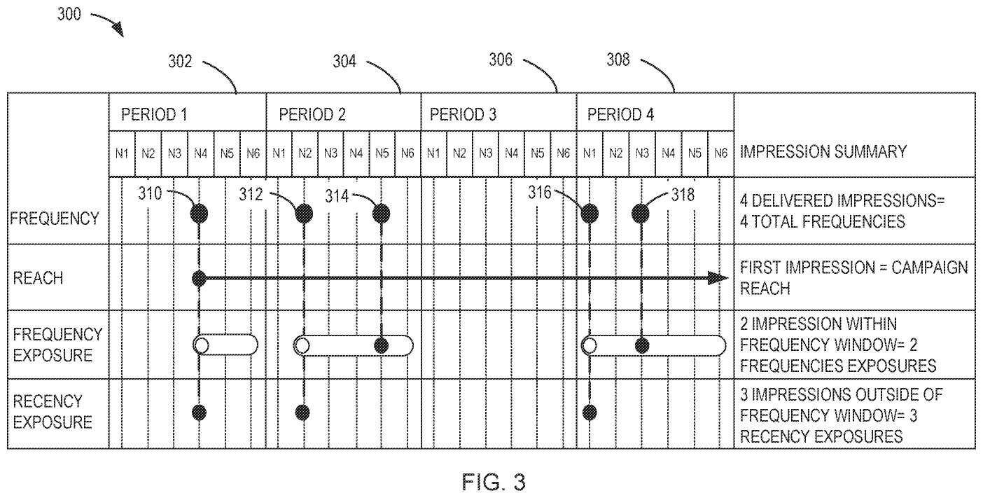

FIG. 3 is a first diagram 300 illustrating a first process that may be implemented by the example exposure analyzing circuitry 108 of FIGS. 1 and/or 2 to classify consumer exposures to a marketing campaign as reach, an iterative frequency exposure, or a recency exposure. The first diagram 300 includes a first time period 302, a second time period 304, a third time period 306, and a fourth time period 308, which define measurement time periods for the marketing campaign. Each of the time periods 302, 304, 306, 308 include n=6 days, however, other values could be used. For instance, the first time period 302 is defined by days n1-n6 and the second time period 304 is defined by a subsequent number of days n1-n6.

In the example of FIG. 3, the exposure identifying circuitry 206 identifies a first exposure 310 of a consumer occurring on day n4 of the first time period 302, a second exposure 312 of the consumer occurring on day n2 of the second time period 304, a third exposure 314 of the consumer occurring on day n5 of the second time period 304, a fourth exposure 316 of the consumer occurring on day n1 of the fourth time period 308, and a fifth exposure 318 of the consumer occurring on day n3 of the fourth time period 308.

The exposure classifying circuitry 208 classifies the first exposure 310 occurring on day n4 of the first time period 302 as reach because the first exposure 310 is the first exposure detected for the marketing campaign. Also, because the first exposure 310 is the first exposure in the first time period 302, the exposure classifying circuitry 208 flags the first exposure 310 for purposes of identifying recency exposures.

In the example of FIG. 3, the window for determining iterative frequency exposures resets at the end of each time period 302, 304, 306, 308. Put another way, in the example of FIG. 3, the frequency window for identifying repeat exposures corresponds to the respective time periods 302, 304, 306, 308. Thus, because no further exposures occurred in the first time period 302, the exposure classifying circuitry 208 does not identify any instances of frequency exposure in the first time period 302.

In the example of FIG. 3, the exposure classifying circuitry 208 recognizes that the second exposure 312 is the first exposure in the second time period 304. Thus, the exposure classifying circuitry 208 classifies the second exposure 312 as a recency exposure (i.e., repeat reach). Also, because the third exposure 314 occurs within the same time period as the second exposure 312 (i.e., the recency exposure for the second time period 304), the exposure classifying circuitry 208 classifies the third exposure 314 as an iterative frequency exposure.

In the example of FIG. 3, because the fourth exposure 316 is the first exposure in the fourth time period 308, the exposure classifying circuitry 208 classifies the exposure as a recency exposure. The exposure classifying circuitry 208 classifies the fifth exposure 318 as an iterative frequency exposure because the exposure occurred within the same time period as the fourth exposure 316.

The example impression reporting circuitry 210 associates the classified exposures with the impressions delivered in the marketing campaign. For example, the impression reporting circuitry 210 determines that with respect to frequency (i.e., repeating a message), there were four total frequencies (i.e., the second exposure 312, the third exposure 314, the fourth exposure 316, and the fifth exposure 318). With respect to the recency exposures, the impression reporting circuitry 210 determines that there were three exposures occurring outside of the frequency windows defined by the respective time periods 302, 304, 306, 308 including the first exposure 310 (which is the reach exposure), the second exposure 312, and the fourth exposure 316. The impression reporting circuitry 210 determines that there were two iterative frequency exposures (i.e., the third exposure 314 and the fifth exposure 318) that were repeated messages within their respective time periods (i.e., the second time period 304 and the fourth time period 308).

Thus, in the example of FIG. 3, the exposure classifying circuitry 208 identifies the recency exposures based on first exposures occurring with each respective time periods 302, 304, 306, 308. In such examples, the first exposures, or the reach events in the respective time periods 302, 304, 306, 308 can serve as proxies for the recency exposures. Thus, the exposure classifying circuitry 208 uses the unique instances of reach in the measurement time periods 302, 304, 306, 308 to identify recency exposures.

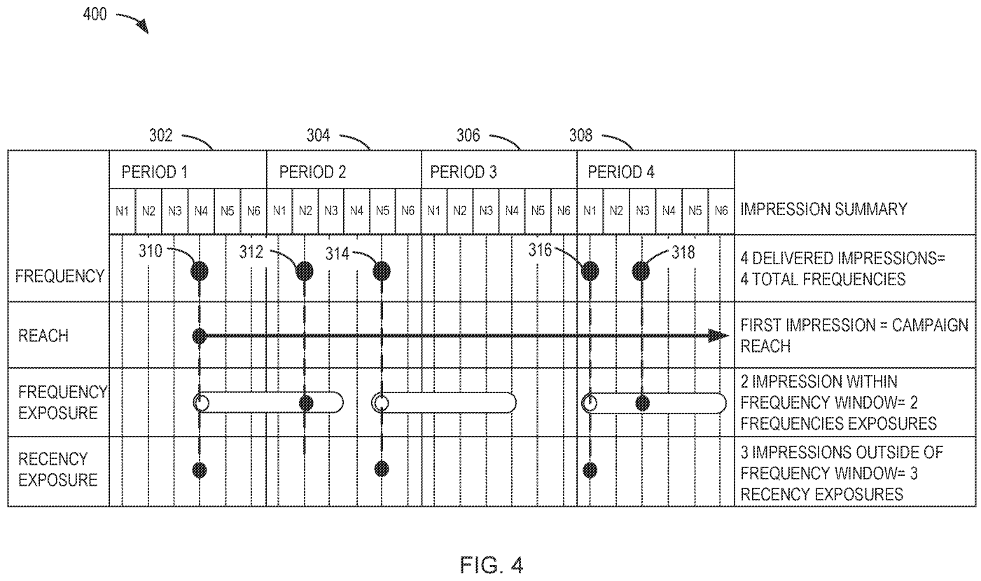

FIG. 4 is a second diagram 400 illustrating a second process that may be implemented by the example exposure analyzing circuitry 108 of FIGS. 1 and/or 2 to classify consumer exposures to a marketing campaign as reach, an iterative frequency exposure, or a recency exposure. The second diagram 400 includes the first time period 302, the second time period 304, the third time period 306, and the fourth time period 308 as disclosed in connection with FIG. 3. The second diagram 400 includes the first, second, third, fourth, and fifth exposures 310, 312, 314, 316, 318 of the consumer to the marketing campaign as disclosed in connection with FIG. 3.

In the example of FIG. 4, the exposure classifying circuitry 208 classifies the first exposure 310 as reach for the campaign because the first exposure 310 is the first exposure detected for the marketing campaign.

In the example of FIG. 4, the window for determining iterative frequency exposures is defined based on the detection of recency exposures and the amount of time n that has passed since the last recency exposure. In the example of FIG. 4, the window for determining iterative frequency exposures relative to a recency exposure is defined as n=6 days (however, other values could be used). Thus, in the example of FIG. 4, because the first exposure 310 is the first exposure within n=6 days, the exposure classifying circuitry 208 identifies the first exposure 310 as a recency exposure. Also, the exposure classifying circuitry 208 identifies the second exposure 312 as an iterative frequency exposure because the second exposure 312 occurred within 6 days of the first exposure 310.

In the example of FIG. 4, the exposure classifying circuitry 208 identifies the third exposure 314 as a recency exposure because the third exposure 314 occurred more than 6 days from the last recency exposure (i.e., the first exposure 310).

In the example of FIG. 4, the exposure classifying circuitry 208 classifies the fourth exposure 316 as a recency exposure because the fourth exposure 316 occurred more than 6 days from the last recency exposure (i.e., the third exposure 314). The exposure classifying circuitry 208 classifies the fifth exposure 318 as an iterative frequency exposure because the fifth exposure 318 occurred within 6 days of the last recency exposure (i.e., the fourth exposure 316).

The example impression reporting circuitry 210 associates the classified exposures with the impressions delivered in the marketing campaign. For example, the impression reporting circuitry 210 determines that with respect to frequency (i.e., repeating a message), there were four total frequencies (i.e., the second exposure 312, the third exposure 314, the fourth exposure 316, and the fifth exposure 318). With respect to the recency exposures, the impression reporting circuitry 210 determines that there were three exposures occurring outside of the frequency windows (i.e., outside of 6 days from a previous recency exposure), including the first exposure 310 (which is also the reach incident), the third exposure 314, and the fourth exposure 316. The impression reporting circuitry 210 determines that there were two iterative frequency exposures (i.e., the second exposure 312 and the fifth exposure 318) that were repeated messages within their respective frequency windows (i.e., within 6 days of the recency exposure defined by the first exposure 310 and the recency exposure defined by the fourth exposure 316).

Thus, FIGS. 3 and 4 illustrate different processes that may be used by the exposure classifying circuitry 208 to classify exposures as frequency exposures or recency exposure based on either a set time period (as disclosed in connection with FIG. 3) or a rolling window associated with the occurrence of recency exposures (as disclosed in connection with FIG. 4).

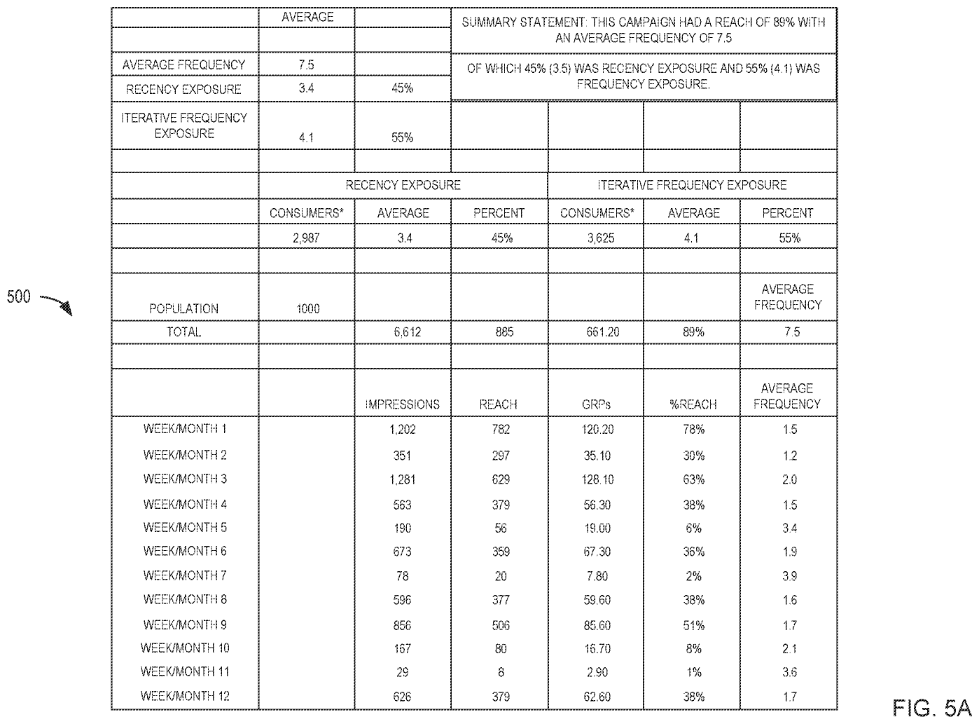

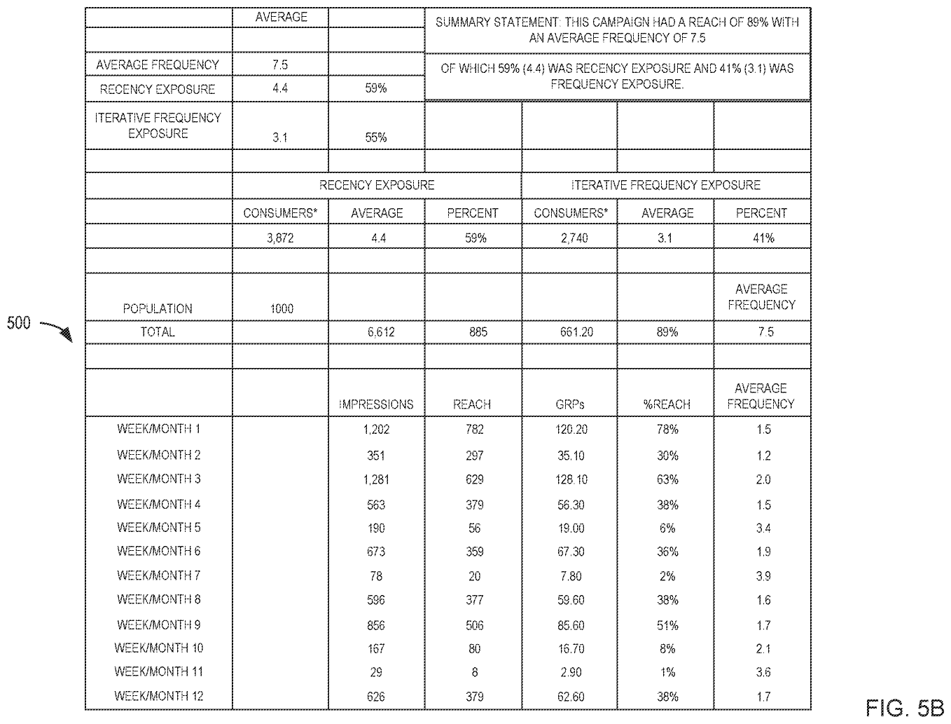

FIG. 5A is a table 500 including sample data used by the example exposure classifying circuitry 208 to differentiate exposures of a consumer population to a marketing campaign using the first process disclosed in connection with FIG. 3 in which the consumer exposures are identified based on a period of time corresponding to a measurement time period for the campaign (e.g., every week, every month).

In the example of FIG. 5A, the exposure classifying circuitry 208 determines the reach of each time period of n number of days, or the unique consumers exposed to the campaign during each time period. In the example of FIG. 5A, the measurement time periods correspond to one week, for a total of 12 weeks, however other time periods such as months (i.e., 4 week periods) could be used. For example, the exposure classifying circuitry 208 determines that the reach of week 1 was 782 for 1,202 impressions delivered.

The exposure classifying circuitry 208 also determines the total reach of the campaign, or the unique consumers exposed to the campaign based on the data in the consumer database 102. In the example of FIG. 5A, the total reach is 885.

The exposure classifying circuitry 208 determines an average frequency value for the campaign based on the total number of impressions and the reach. In the example of FIG. 5A, the exposure classifying circuitry 208 determines the average frequency value as:

Average Frequency=Total Delivered Impressions/Total Reach=6612/885=7.5.

As disclosed herein, the exposure classifying circuitry 208 distinguishes the types of frequency exposures as recency exposures and iterative frequency exposures. To determine recency exposure, the exposure classifying circuitry 208 sums the reach of each time period. The exposure classifying circuitry 208 and subtracts total reach from the sum of the reach of each time period to calculate a consumers recency exposure value. In particular, the consumers recency exposure value can be calculated as:

Consumers Recency Exposure=Sum of Reach of Each Time Period—Total Campaign Reach=Sum(782+297+629+379+56+359+20+377+506+80+8+379)−885=2,987.

The exposure classifying circuitry 208 calculates an average recency exposure value by dividing the consumers recency exposure by the total reach for the campaign. In the example of FIG. 5A, the exposure classifying circuitry 208 calculates the average recency exposure value as:

Average Recency Exposure=Consumers Recency Exposure/Total Reach=2987/885=3.4.

The exposure classifying circuitry 208 calculates a percentage of recency exposures by dividing the consumers recency exposure value by the total impressions. In the example of FIG. 5A, the exposure classifying circuitry 208 calculates the percentage of recency exposures as:

Percentage of Recency Exposures=Consumers Recency Exposure/Total Impressions=2987/6612=45%.

With respect to determining the iterative frequency exposures, the exposure classifying circuitry 208 calculates consumers frequency exposure value by subtracting the consumers recency exposures from the total impressions. In the example of FIG. 5A, the exposure classifying circuitry 208 calculates the consumers frequency exposure value as:

Consumers Frequency Exposure=Total Impressions−Consumers Recency Exposure=6612−2987=3625.

The exposure classifying circuitry 208 calculates an average frequency exposure value by dividing the consumers frequency exposure by the total campaign reach. In the example of FIG. 5A, the exposure classifying circuitry 208 calculates the average frequency exposure value as:

Average Frequency Exposure=Consumers Frequency Exposure/Total Reach=3625/885=4.1.

The exposure classifying circuitry 208 calculates a percentage of frequency exposures by dividing the consumers frequency exposure by the total impressions. In the example of FIG. 5A, the exposure classifying circuitry 208 calculates the percentage of frequency exposures as:

Percentage of Frequency Exposures=Consumers Frequency Exposure/Total Impressions=3625/6612=55%.

Thus, in the example of FIG. 5A, the exposure classifying circuitry 208 determines that the average frequency for the marketing campaign was 7.5, the recency exposure was 3.4, and the frequency exposure was 4.1. Therefore, the exposure classifying circuitry 208 separates the frequency metric into recency exposure and iterative frequency exposures (i.e., average frequency=average recency exposures+average iterative frequency exposures). In the example of FIG. 5A, the exposure classifying circuitry 208 determines that 45% of the frequency was recency exposures and 55% of the frequency was iterative frequency exposures.

FIG. 5B includes the table 500 with sample data used by the example exposure classifying circuitry 208 to differentiate exposures of a consumer population to a marketing campaign using the first process disclosed in connection with FIG. 3 in which the consumer exposures are identified based on a period of time corresponding to a measurement time period for the campaign (e.g., every week, every month). In the example of FIG. 5B, the exposure classifying circuitry 208 treats the initial reach exposure as recency as compared to the approach of FIG. 5A, in which the exposure classifying circuitry subtracted the total reach from the sum of the reach of each time period to calculate the consumers recency exposure.

In the example of FIG. 5B, the exposure classifying circuitry 208 determines the reach of each time period of n number of days, or the unique consumers exposed to the campaign during each time period. In the example of FIG. 5B, the measurement time periods correspond to one week, for a total of 12 weeks, however other time periods such as months (i.e., 4 week periods) could be used. For example, the exposure classifying circuitry 208 determines that the reach of week 1 was 782 for 1,202 impressions delivered.

The exposure classifying circuitry 208 also determines the total reach of the campaign, or the unique consumers exposed to the campaign based on the data in the consumer database 102. In the example of FIG. 5B, the total reach is 885.

The exposure classifying circuitry 208 determines an average frequency value for the campaign based on the total number of impressions and the reach. In the example of FIG. 5B, the exposure classifying circuitry 208 determines the average frequency value as:

Average Frequency=Total Delivered Impressions/Total Reach=6612/885=7.5.

To determine recency exposure, the exposure classifying circuitry 208 sums the reach of each time period. In the example of FIG. 5B, the exposure classifying circuitry 208 calculates the consumers recency exposure value as:

Consumers Recency Exposure=Sum of Reach of Each Time Period=Sum(782+297+629+379+56+359+20+377+506+80+8+379)=3,872.

Thus, as compared to the approach of FIG. 5A, in the example of FIG. 5B, the exposure classifying circuitry 208 does not subtract the total reach (i.e., 885) from the sum of the reach of each time period to calculate the consumers recency exposure. Instead, in the example of FIG. 5B, reach (i.e., initial exposure or the unique audience exposed to the marketing campaign) is included as recency.

The exposure classifying circuitry 208 calculates an average recency exposure value by dividing the consumers recency exposure by the total reach for the campaign. In the example of FIG. 5B, the exposure classifying circuitry 208 calculates the average recency exposure value as:

Average Recency Exposure=Consumers Recency Exposure/Total Reach=3872/885=4.4.

The exposure classifying circuitry 208 calculates a percentage of recency exposures by dividing the consumers recency exposure value by the total impressions. In the example of FIG. 5B, the exposure classifying circuitry 208 calculates the percentage of recency exposures as:

Percentage of Recency Exposures=Consumers Recency Exposure/Total Impressions=3872/6612=59%.

With respect to determining the iterative frequency exposures, the exposure classifying circuitry 208 calculates consumers frequency exposure value by subtracting the consumers recency exposures from the total impressions. In the example of FIG. 5B, the exposure classifying circuitry 208 calculates the consumers frequency exposure value as:

Consumers Frequency Exposure=Total Impressions−Consumers Recency Exposure=6612−3872=2,740.

The exposure classifying circuitry 208 calculates an average frequency exposure value by dividing the consumers frequency exposure by the total campaign reach. In the example of FIG. 5B, the exposure classifying circuitry 208 calculates the average frequency exposure value as:

Average Frequency Exposure=Consumers Frequency Exposure/Total Reach=2740/885=3.1.

The exposure classifying circuitry 208 calculates a percentage of frequency exposures by dividing the consumers frequency exposure by the total impressions. In the example of FIG. 5B, the exposure classifying circuitry 208 calculates the percentage of frequency exposures as:

Percentage of Frequency Exposures=Consumers Frequency Exposure/Total Impressions=2740/6612=41%.

Thus, in the example of FIG. 5B, the exposure classifying circuitry 208 determines that the average frequency for the marketing campaign was 7.5, the recency exposure was 4.4, and the frequency exposure was 3.1. As disclosed in connection with FIG. 5A, the exposure classifying circuitry 208 separates the frequency metric into recency exposure and iterative frequency exposures (i.e., average frequency=average recency exposures+average iterative frequency exposures). In the example of FIG. 5B, the exposure classifying circuitry 208 determines that 59% of the frequency was recency exposures and 41% of the frequency was iterative frequency exposures. In the example of FIG. 5B, the recency exposure is greater than the recency exposure determined in FIG. 5A because the exposure classifying circuitry 208 treated initial reach as a recency exposure.

Flowcharts representative of example machine readable instructions, which may be executed to configure processor circuitry to implement the exposure analyzing circuitry 108 of FIG. 2, are shown in FIGS. 6-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 6-8, many other methods of implementing the example exposure analyzing circuitry 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to classify consumer exposures to a marketing campaign. The machine readable instructions and/or the operations 600 of FIG. 6 begin at block 602, at which the data retrieval circuitry 202 obtains input data sets from the consumer database 102.

At block 604, the window defining circuitry 204 determines the time periods for analyzing the marketing campaign based on user inputs. The user inputs can define, for instance, n number of days of the time periods and whether the frequency window should be a set window corresponding to the time periods or a rolling window based on the occurrence of recency exposures.

At block 606, the exposure identifying circuitry 206 identifies instances of exposure of the consumers to the delivered impressions of the campaign based on the data from the consumer database 102.

At block 608, the exposure classifying circuitry 208 determines a total reach for the marketing campaign, or a number of unique consumers exposed to the marketing campaign based on the exposures indicating a first exposure to the campaign.

At block 610, the exposure classifying circuitry 208 determines an average frequency of the marketing campaign, or a number of repeated exposures of consumers to the marketing campaign (e.g., Average Frequency=Total Delivered Impressions/Total Reach).

At block 612, the exposure classifying circuitry 208 determines a portion of the frequency corresponding to recency exposure(s) and a portion of the frequency corresponding to iterative frequency exposure(s), as disclosed in connection with the flowchart of FIG. 7 or the flowchart of FIG. 8.

If there are additional data inputs to analyze, the instructions of FIG. 6 return to block 604 to define the time periods for the additional data sets. If there are no additional data sets to analyze, the impression reporting circuitry 210 outputs the reach, frequency, iterative frequency exposure, and recency exposures with respect to the delivered impressions for the campaign at block 616. The instructions 600 of FIG. 6 end at block 618.

FIG. 7 is a flowchart representative of example machine readable instructions and/or example operations 612 that may be executed and/or instantiated by processor circuitry to determine a portion of the frequency associated with recency exposure(s) and a portion of frequency associated with iterative frequency exposure(s). In particular, the example instructions of FIG. 7 determine the recency exposure(s) and the iterative frequency exposure(s) based on the respective time periods of the marketing campaign. Put another way, in the example of FIG. 7, the frequency window corresponds to the measurement time periods for the marketing campaign (e.g., based on user inputs received by the window defining circuitry 204).

The instructions of FIG. 7 begin at block 700 in which the exposure classifying circuitry 208 determines if an exposure has been detected in a measurement time period of the campaign. At block 702, the exposure classifying circuitry 208 determines if the exposure corresponds to the first exposure in the time period other than the exposure identified by the exposure classifying circuitry 208 as an initial reach exposure (e.g., a block 608 of FIG. 6). At block 704, if the first exposure in the time period is a first exposure other than reach (i.e., the initial exposure to the campaign), the exposure classifying circuitry 208 identifies the exposure as a recency exposure (i.e., repeat reach).

At block 706, the exposure classifying circuitry 208 determines if another exposure is detected in the same time period. If another exposure is detected in the same time period, the exposure classifying circuitry 208 classifies the exposure as an iterative frequency exposure (i.e., a repeat exposure in the time period) at block 708.

In the example of FIG. 7, control returns to block 612 of FIG. 6 when there are no further time periods to analyze (blocks 710, 712).

FIG. 8 is another flowchart representative of example machine readable instructions and/or example operations 612 that may be executed and/or instantiated by processor circuitry to determine a portion of the frequency associated with recency exposure(s) and a portion of frequency associated with iterative frequency exposure(s). In particular, the example instructions of FIG. 8 determine the recency and iterative frequency exposure(s) based on rolling window(s) for identifying iterative frequency exposure(s) that is defined by the occurrence of recency exposure(s) (e.g., based on user inputs received by the window defining circuitry 204).

The instructions of FIG. 8 begin at block 800 at which the exposure classifying circuitry 208 determines if an exposure has been detected within a defined window of time. At block 802, the exposure classifying circuitry 208 determines if the exposure has occurred with n days of the exposure representing reach. If the exposure has occurred within n days of initial reach exposure, then the exposure classifying circuitry 208 defines the exposure as an iterative frequency exposure at block 804.

At block 806, the exposure classifying circuitry 208 determines if an exposure has been detected outside of the window including the initial reach exposure. If an exposure has occurred outside of the window including the reach exposure, the exposure classifying circuitry 208 classifies the exposure as a recency exposure at block 808.

At block 810, the exposure classifying circuitry 208 determines if an exposure has been detected within n days of the last recency exposure (i.e., the recency exposure detected at block 808). If the exposure classifying circuitry 208 detects an exposure within n days of the last recency exposure, the exposure classifying circuitry 208 classifies the exposure as an iterative frequency exposure at block 812.

At block 814, the exposure classifying circuitry 208 determines if an exposure has been detected outside of n days of the last recency exposure. If the exposure classifying circuitry 208 identifies an exposure has been detected outside of n days of the last recency exposure, the exposure classifying circuitry 208 classifies the exposure as a recency exposure at block 816.

In the example of FIG. 8, control returns to block 612 of FIG. 6 when there are no further frequency windows to analyze (block 818, 820).

FIG. 9 is a block diagram of an example processor platform 900 structured to execute and/or instantiate the machine readable instructions and/or the operations of FIGS. 6-8 to implement the exposure analyzing circuitry 108 of FIGS. 1 and/or 2. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 912 implements the example data retrieval circuitry 202, the example window defining circuitry 204, the example exposure identifying circuitry 206, the example exposure classifying circuitry 208, and the example impression reporting circuitry 210.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 6-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 6-8 to effectively instantiate the circuitry of FIG. 2 as logic circuits to perform the operations corresponding to those machine readable instructions. In some such examples, the circuitry of FIG. 2 is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIG. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 6-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 6-8. As such, the FPGA circuitry 1100 may be structured to effectively instantiate some or all of the machine readable instructions of the flowcharts of FIGS. 6-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 6-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed, or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 65. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 6-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 6-8 may be executed by one or more of the cores 1002 of FIG. 10, a second portion of the machine readable instructions represented by the flowcharts of FIGS. 6-8 may be executed by the FPGA circuitry 1100 of FIG. 11, and/or a third portion of the machine readable instructions represented by the flowcharts of FIGS. 6-8 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that classify exposures to content such as a marketing campaign based on frequency including recency exposures and iterative frequency exposures. Disclosed systems, methods, apparatus, and articles of manufacture improve the efficiency of using a computing device by transforming instances of reach in a time period associated with the campaign into a measure of recency exposure. As a result, examples disclosed herein prevent inefficient use of computing resources in determining reach and recency. Disclosed systems, methods, apparatus, and articles of manufacture are accordingly directed to one or more improvement(s) in the operation of a machine such as a computer or other electronic and/or mechanical device.

Example apparatus, systems, methods, and articles of manufacture to identify consumer content exposure are disclosed herein. Further examples and combinations thereof include the following:

Example 1 includes an apparatus comprising at least one memory; machine readable instructions; and processor circuitry to at least one of instantiate or execute the machine readable instructions to detect a first exposure of a first consumer to a marketing campaign during a first time period; identify the first exposure as a first recency exposure; detect a second exposure of the first consumer to the marketing campaign during one of the first time period or a second time period; when the second exposure is detected during the first time period, identify the first time period as an iterative frequency exposure; and when the second exposure is detected during the second time period, identify the second exposure as a second recency exposure.

Example 2 includes the apparatus of example 1, wherein the processor circuitry to further identify the first recency exposure as reach.

Example 3 includes the apparatus of examples 1 or 2, wherein the processor circuitry is to further identify the first recency exposure as reach for the second time period.

Example 4 includes the apparatus of any of examples 1-3, wherein the processor circuitry is to calculate a sum the reach for the first consumer and reach identified for a plurality of other consumers in the first time period and the second time period to determine a total reach of the marketing campaign; and determine a consumers recency exposure value for the marketing campaign based on the total reach.

Example 5 includes the apparatus of any of examples 1-4, wherein the processor circuitry is to determine an average recency exposure value based on the consumers recency exposure value and the total reach.

Example 6 includes the apparatus of any of examples 1-5, wherein the processor circuitry is to determine a consumers frequency exposure value based on a total number of impressions for the marketing campaign and the consumers recency exposure value.

Example 7 includes the apparatus of any of examples 1-6, wherein the processor circuitry is to define the second time period based on the identification of the first recency exposure and define a third time period based on the identification of the second recency exposure.

Example 8 includes the apparatus of any of examples 1-7, wherein the processor circuitry is to identify the second exposure as the iterative frequency exposure and determine a total frequency exposure value for the marketing campaign based on the iterative frequency exposure and the first recency exposure.

Example 9 includes a non-transitory machine readable storage medium comprising instructions that, when executed, cause processor circuitry to at least identify a first exposure of respective ones of consumers to an advertisement of a marketing campaign in a first time period as reach; identify a second exposure of the respective ones of the consumers to the advertisement in the first time period or a second time period as a frequency exposure; classify the respective frequency exposures as one of a recency exposure or an iterative frequency exposure; and output a report including the reach and the classifications of the frequency exposures for the advertisement for a duration of the marketing campaign.

Example 10 includes the non-transitory machine readable storage medium of example 9, wherein the processor circuitry is to classify the respective frequency exposures as the iterative frequency exposure when the frequency exposures occur in the first time period.

Example 11 includes the non-transitory machine readable storage medium of examples 9 or 10, wherein the processor circuitry is to classify the respective frequency exposures as a recency exposure when the frequency exposures occur in the second time period.

Example 12 includes the non-transitory machine readable storage medium of any of examples 9-11, wherein the processor circuitry is to classify the frequency exposure for one of the consumers in the second time period as a recency exposure and define a third time period for the consumer based on a date of the recency exposure.

Example 13 includes the non-transitory machine readable storage medium of any of examples 9-12, wherein the processor circuitry is to classify a third exposure of the consumer in the third time period as an iterative frequency exposure.

Example 14 includes the non-transitory machine readable storage medium of any of examples 9-13, wherein the processor circuitry is to classify the reach in the first time period for each consumer as a recency exposure.

Example 15 includes the non-transitory machine readable storage medium of any of examples 9-14, wherein the processor circuitry is to determine a consumers recency exposure value based on the recency exposures in each time period of the marketing campaign including the recency exposures corresponding to the reach.

Example 16 includes an apparatus comprising interface circuitry to obtain consumer exposure data for impressions delivered during a marketing campaign; and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus; a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or Application Specific Integrated Circuitry (ASIC) including logic gate circuitry to perform one or more third operations; the processor circuitry to perform at least one of the first operations, the second operations, or the third operations to instantiate: exposure identifying circuitry to identify exposures of a consumer to the marketing campaign during respective time periods of the marketing campaign; and exposure classifying circuitry to identify respective ones of the exposures as a reach exposure or a frequency exposure; and classify the respective ones of the frequency exposures as a recency exposure or an iterative frequency exposure.

Example 17 includes the apparatus of example 16, wherein the processor circuitry is to perform at least one of the first operations, the second operations, or the third operations to instantiate window defining circuitry to define the time periods of the marketing campaign based on classification of the frequency exposures as recency exposures.

Example 18 includes the apparatus of examples 16 or 17, wherein the exposure classifying circuitry is to classify the reach exposure as a recency exposure.

Example 19 includes the apparatus of any of examples 16-18, wherein the exposure classifying circuitry is determine a consumers recency exposure value based on the recency exposures in each time period of the marketing campaign including the recency exposures corresponding to the reach.

Example 20 includes the apparatus of any of examples 16-19, wherein the exposure classifying circuitry is to classify one of the frequency exposures as an iterative frequency exposure when the frequency exposure occurs in a same time period as a recency exposure.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
machine readable instructions; and
processor circuitry to at least one of instantiate or execute the machine readable instructions to:
detect a first exposure of a first consumer to a marketing campaign during a first time period;
identify the first exposure as a first recency exposure;
detect a second exposure of the first consumer to the marketing campaign during one of the first time period or a second time period;
when the second exposure is detected during the first time period, identify the first time period as an iterative frequency exposure; and
when the second exposure is detected during the second time period, identify the second exposure as a second recency exposure.

2. The apparatus of claim 1, wherein the processor circuitry to further identify the first recency exposure as reach.

3. The apparatus of claim 2, wherein the processor circuitry is to further identify the first recency exposure as reach for the second time period.

4. The apparatus of claim 3, wherein the processor circuitry is to:
calculate a sum the reach for the first consumer and reach identified for a plurality of other consumers in the first time period and the second time period to determine a total reach of the marketing campaign; and
determine a consumers recency exposure value for the marketing campaign based on the total reach.

5. The apparatus of claim 4, wherein the processor circuitry is to determine an average recency exposure value based on the consumers recency exposure value and the total reach.

6. The apparatus of claim 4, wherein the processor circuitry is to determine a consumers frequency exposure value based on a total number of impressions for the marketing campaign and the consumers recency exposure value.

7. The apparatus of claim 1, wherein the processor circuitry is to define the second time period based on the identification of the first recency exposure and define a third time period based on the identification of the second recency exposure.

8. The apparatus of claim 1, wherein the processor circuitry is to identify the second exposure as the iterative frequency exposure and determine a total frequency exposure value for the marketing campaign based on the iterative frequency exposure and the first recency exposure.

9. A non-transitory machine readable storage medium comprising instructions that, when executed, cause processor circuitry to at least:
identify a first exposure of respective ones of consumers to an advertisement of a marketing campaign in a first time period as reach;
identify a second exposure of the respective ones of the consumers to the advertisement in the first time period or a second time period as a frequency exposure;
classify the respective frequency exposures as one of a recency exposure or an iterative frequency exposure; and
output a report including the reach and the classifications of the frequency exposures for the advertisement for a duration of the marketing campaign.

10. The non-transitory machine readable storage medium of claim 9, wherein the processor circuitry is to classify the respective frequency exposures as the iterative frequency exposure when the frequency exposures occur in the first time period.

11. The non-transitory machine readable storage medium of claim 9, wherein the processor circuitry is to classify the respective frequency exposures as a recency exposure when the frequency exposures occur in the second time period.

12. The non-transitory machine readable storage medium of claim 9, wherein the processor circuitry is to classify the frequency exposure for one of the consumers in the second time period as a recency exposure and define a third time period for the consumer based on a date of the recency exposure.

13. The non-transitory machine readable storage medium of claim 12, wherein the processor circuitry is to classify a third exposure of the consumer in the third time period as an iterative frequency exposure.

14. The non-transitory machine readable storage medium of claim 9, wherein the processor circuitry is to classify the reach in the first time period for each consumer as a recency exposure.

15. The non-transitory machine readable storage medium of claim 14, wherein the processor circuitry is to determine a consumers recency exposure value based on the recency exposures in each time period of the marketing campaign including the recency exposures corresponding to the reach.

16. An apparatus comprising:
interface circuitry to obtain consumer exposure data for impressions delivered during a marketing campaign; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
exposure identifying circuitry to identify exposures of a consumer to the marketing campaign during respective time periods of the marketing campaign; and
exposure classifying circuitry to:
identify respective ones of the exposures as a reach exposure or a frequency exposure; and
classify the respective ones of the frequency exposures as a recency exposure or an iterative frequency exposure.

17. The apparatus of claim 16, wherein the processor circuitry is to perform at least one of the first operations, the second operations, or the third operations to instantiate window defining circuitry to define the time periods of the marketing campaign based on classification of the frequency exposures as recency exposures.

18. The apparatus of claim 16, wherein the exposure classifying circuitry is to classify the reach exposure as a recency exposure.

19. The apparatus of claim 18, wherein the exposure classifying circuitry is determine a consumers recency exposure value based on the recency exposures in each time period of the marketing campaign including the recency exposures corresponding to the reach.

20. The apparatus of claim 16, wherein the exposure classifying circuitry is to classify one of the frequency exposures as an iterative frequency exposure when the frequency exposure occurs in a same time period as a recency exposure.
